(19) United States
(12) Patent Application Publication
(10) Pub. No.: US 2013/0270461 A1
(43) Pub. Date: Oct. 17, 2013

(54) SMART MEMORY ALLOYS FOR AN EXTREME ULTRA-VIOLET (EUV) RETICLE INSPECTION TOOL

(71) Applicant: KLA-TENCOR CORPORATION, Milpitas, CA (US)

(72) Inventors: Gildardo Delgado, Livermore, CA (US); Frank Chilese, San Ramon, CA (US)

(73) Assignee: KLA-Tencor Corporation, Milpitas, CA (US)

(21) Appl. No.: 13/860,198

(22) Filed: Apr. 10, 2013

Related U.S. Application Data
(60) Provisional application No. 61/623,564, filed on Apr. 13, 2012.

(51) Int. Cl. G21K 5/10; G21K 5/04

(52) U.S. Cl. CPC G21K 5/10; G21K 5/04
USPC 250/505.1; 250/522.1

(57) ABSTRACT

An apparatus for actinic extreme ultra-violet (EUV) reticle inspection including at least one shape memory metal actuator adapted to displace an inspection component in an EUV inspection tool. An apparatus for actinic EUV reticle inspection including a tilt mechanism including at least one shape memory metal actuator adapted to angularly displace an inspection component in an EUV inspection tool. An apparatus for actinic EUV reticle inspection, including a translation stage adapted to fixedly connect to an inspection component, at least one flexure stage, and at least one shape memory metal actuator adapted to displace the translation stage.

### CROSS-REFERENCE TO RELATED APPLICATIONS

This patent application claims the benefit under 35 U.S.C. §119(e) of U.S. Provisional Patent Application No. 61/623,564, filed Apr. 13, 2012, which application is incorporated herein by reference.

### FIELD OF THE INVENTION

The present invention broadly relates to reticle inspection tools, and, more particularly, to shape memory metal alloys used in reticle inspection tools with actinic extreme ultraviolet imaging.

### BACKGROUND OF THE INVENTION

Current EUV reticle inspection tools use hybrid air-bearing and magnetic levitation (mag-lev) stages for reticle loading. These stages utilize numerous components to move the stage into various positions. The operation of hybrid air-bearing and mag-lev stages significantly increases the number of particles in the air which could settle onto the patterned surface of the reticle.

Inspecting an EUV reticle at deep ultra-violet (DUV) wavelengths limits the detection of defects in the reticle pattern, while EUV reticle inspection tools exhibit issues with particles settling onto the patterned surface of the reticle. EUV inspection systems are extremely sensitive to particle and molecular contamination. Moving parts and chemicals used inside the inspection tool create particles that negatively impact the optics used for inspection. Contamination and particle accumulation decrease the lifespan of spectral purity filters (SPF), grazing and normal incidence angle mirrors, collectors and sensors. Movements or actuation inside the inspection tool are linear translations, rotations (roll, pitch, and yaw), clamping, shaping, or bending components. This motion aids in the sensitive alignment of reticle inspection components and in correcting misaligned components. Additional movement occurs through the use of simple direct drive actuators that move components that require translation, rotation, or indexing.

Historically, only a limited number of options exist to facilitate motion inside a vacuum environment. Most common are piezoelectric actuators, electromagnetic (solenoid) actuators, and rotary or linear electric motors. Motion sources that use a rubbing contact, such as long-stroke piezoelectric actuators, electromagnetic actuators, and electric motors, create a substantial number of particles and outgassing chemical compounds during operation. The contact of various components against each other generates a myriad of particles, especially in a vacuum environment. Current solutions to contain these particles are large and add complexity to the motor or actuator. Adding lubricants or materials that provide improved lubricity add chemical contamination to the inspection tool due to increased out gassing. Moreover, many actuators are complex assemblies that require materials that produce chemical contamination. One such example is the epoxy used to hold two elements together.

Presently, there are no satisfactory methods to control particles down to a size of 10 nanometers (nm) without generating particles or chemical contamination. Thus, there is a long-felt need to improve upon the shortcomings of contamination control mechanisms for use in vacuum EUV reticle inspection systems.

### SUMMARY OF THE INVENTION

The present invention broadly comprises an apparatus for actinic extreme ultra-violet (EUV) reticle inspection including at least one shape memory metal actuator adapted to displace an inspection component in an EUV inspection tool.

Furthermore, the present invention broadly comprises an apparatus for actinic extreme ultra-violet (EUV) reticle inspection including a tilt mechanism including at least one shape memory metal actuator adapted to angularly displace an inspection component in an EUV inspection tool.

Moreover, the present invention broadly comprises an apparatus for actinic extreme ultra-violet (EUV) reticle inspection, including a translation stage adapted to fixedly connect to an inspection component, at least one flexure stage, and at least one shape memory metal actuator adapted to displace the translation stage.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a schematic diagram of a multi-angle tilt mechanism with shape memory metal actuators;

FIG. 1B is a schematic diagram of a single angle tilt mechanism with one shape memory metal actuator; and,

FIG. 2 is a schematic of a translation stage with opposing shape memory metal actuators.

### DETAILED DESCRIPTION OF THE INVENTION

At the outset, it should be appreciated that like drawing numbers on different drawing views identify identical, or functionally similar, structural elements of the invention. It also should be appreciated that figure proportions and angles are not always to scale in order to clearly portray the attributes of the present invention.

While the present invention is described with respect to what is presently considered to be the preferred aspects, it is to be understood that the invention as claimed is not limited to the disclosed aspects. The present invention is intended to cover various modifications and equivalent arrangements included within the spirit and scope of the appended claims.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Although any methods, devices or materials similar or equivalent to those described herein can be used in the practice or testing of the invention, the preferred methods, devices, and materials are now described.

Several items within an actinic EUV reticle inspection tool require simple actuation. Current actuation devices, such as piezoelectric actuators, electromagnetic actuators, and rotary or linear electric motors, result in rubbing contact during movement. This rubbing contact creates a myriad of particles inside the inspection tool. Particularly in a vacuum environment, rubbing creates and ejects numerous particles. Present options to contain particles are large in size and add complexity to the inspection tool. In addition, as described above, the use of lubricants introduces chemical contamination into the vacuum environment of the reticle inspection tool. The gaseous emission of lubricants inside the vacuum environment negatively impacts the performance of optical components. Moreover, numerous actuators are complex assemblies requiring materials that produce chemical contamination, e.g., epoxy for holding elements together, without the use of lubricants. The present invention is used in a reticle inspection tool. Accordingly, a general description of a reticle inspection tool is provided to better understand the use of the present invention within a reticle inspection tool.

An actinic EUV reticle inspection tool allows for inspection at EUV wavelengths without the large size and particulate addition problems encountered by other EUV lithography tools. The actinic EUV reticle inspection tool may include multiple EUV sources as an illumination source for the inspection tool. A single DPP or LPP EUV source may not provide sufficient brightness to illuminate the patterned face of the reticle, while the introduction of multiple EUV sources provides the necessary brightness to properly inspect the reticle.

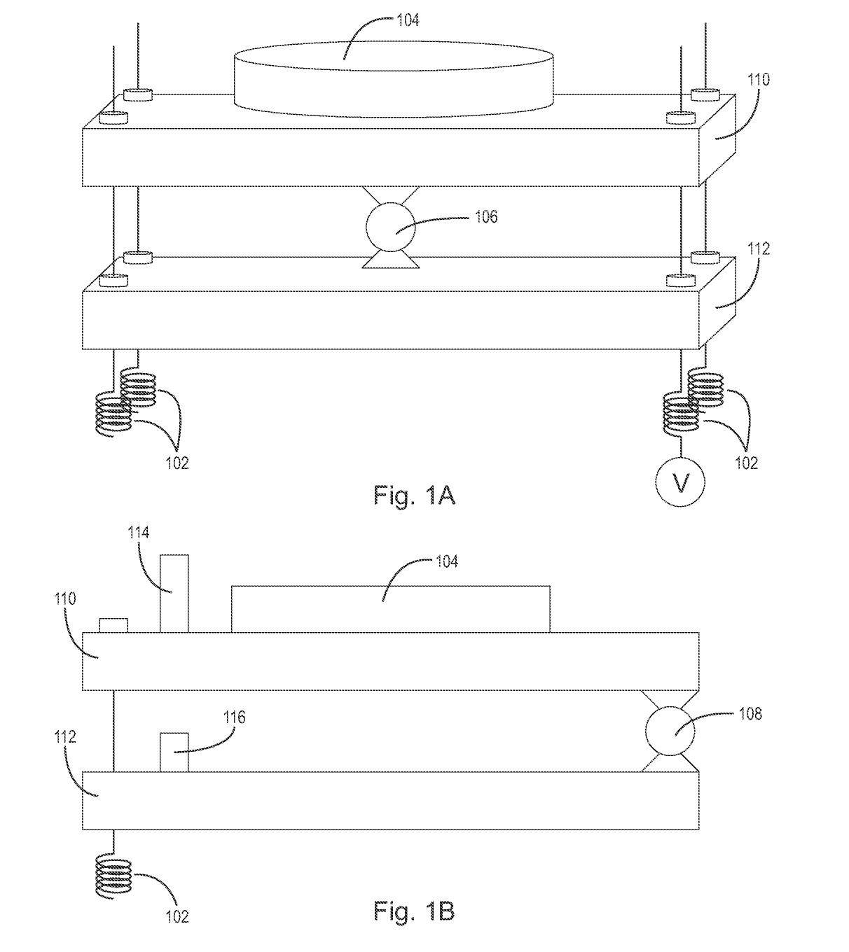

FIG. 1A depicts an embodiment of the present invention, i.e., an apparatus for actinic EUV reticle inspection comprising at least one shape memory metal actuator 102 adapted to displace inspection component 104 in an EUV inspection tool. A shape memory metal is an alloy with a predetermined cold forged state and a deformed state when heated. In a natural position, the shape memory metal is static in its predetermined shape. When heat is applied, e.g., through an electric current, the shape memory metal changes or deforms into a new heated shape. Once the heat source is removed from the shape memory metal and the metal cools, the metal returns to its natural static position, i.e., original position. Use of a shape memory metal actuator allows for movement inside the reticle inspection tool without the introduction of particles or contamination. The shape memory metal actuator is connected to an inspection component, which in some embodiments holds the reticle being inspected. Sending an electric current or heat source through the shape memory actuator connected to an inspection component causes the inspection component to displace. Since there is no rubbing of parts or lubricants involved, the shape memory metal displaces the inspection component with minimal, if any, introduction of particles into the vacuum chamber of the inspection tool. Shape memory metal actuators provide high power-to-volume ratios comparable to hydraulic actuation, without the need of a force-transmitting fluid.

Shape memory metals are beneficial in actuating mechanical devices with dimensions in the micron to millimeter range that require large forces over long displacements. Shape memory metals also offer advantages in compact actuation scenarios, such as small displacements in reticle inspection tools. Using shape memory metals allows for less mass, power consumption, and cost for inspection tools. Moreover, shape memory metals are low profile, lightweight, space saving, and operate quietly. Shape memory metal actuators require a low electrical current with simple resistive heating to cause actuation.

In an example embodiment, at least one of shape memory metal actuators 102 includes, but is not limited to, shapes such as a wire, a ribbon, a rod, a sheet or a micro-machined shape. The use of a shape memory metal wire provides actuation solutions that allow the elimination of solenoids and motors, thereby providing particle-free actuation in sensitive EUV environments. A micro-machined shape is a mechanical object fabricated on an extremely small scale. Some micro-machined shapes are fabricated in a similar manner as integrated circuits. Fabrication of micro-machined shapes typically occurs through surface micro-machining or bulk micro-machining. Surface micro-machining uses a succession of thin film deposition and selective etching to form the micro-machined shape. However, bulk micro-machining defines structures by selectively etching inside a substrate.

In an embodiment, inspection component 104 includes, but is not limited to, a spectral purity filter, a grazing incidence angle mirror, a collector, or a sensor. In an embodiment, inspection component 104 is displaced in a translational motion. Translational motion occurs when an object is displaced without a change in orientation relative to a fixed point. The translation may occur on a straight line, curved path, or sporadic path. Whichever path the object moves, the orientation remains unchanged relative to a fixed point. In addition, an embodiment of the present invention includes inspection component 104 displacing in rotational motion. Rotational movement is when an object turns about an axis or fixed point. FIG. 1A illustrates a multi angle tilt mechanism using frictionless pivot 106 and shape memory metal actuators 102, while FIG. 1B portrays a single angle tilt mechanism using frictionless pivot 108 and shape memory actuator 102. Application of heat to actuators 102, e.g., through applying an electric current, causes stage 110 to shift relative to stage 112 and thereby affecting movement of component 104, while removing the application of heat causes stage 110 to return to its original position relative to stage 112. In various embodiments, the rotational motion can be about a single pivot point or a plurality of pivots. The number of pivot points depends on the necessary movement of inspection component 104. A reticle inspection tool requiring complex movement of the inspection component will require multiple pivots to achieve the desired actuation. For example, two pivots located at opposing corners would permit rotational movement about a line formed between the points of contact of the two pivots.

In an embodiment, the present invention includes at least one precision hard stop adapted to locate a destination position for the inspection component, precision hard stop 114 and 116. One use of shape memory metals is to induce motion from a first hard stop position to a second hard stop position for an inspection component, or other mechanisms, moving from one known location to another. Shape memory metals create the force that pulls or pushes an object, such as an inspection component, to a predetermined location. Shape memory metals may be one-way or two-way metals. As used herein, “one-way metal” is intended to mean a metal that takes a specific shape when heated, but then relaxes and takes on any shape that the environment pushes it when cold. Furthermore, as used herein “two-way metal” is intended to mean a metal that remembers two specific shapes, i.e., a first shape when hot and a second shape when cold.

In an embodiment, the present invention comprise an apparatus for actinic EUV reticle inspection including a tilt mechanism 108 including at least one shape memory metal actuator 102 adapted to angularly displace inspection component 104 in an EUV inspection tool. As depicted in FIG. 1B, tilt mechanism 108 pivots when shape memory metal actuator 102 imparts a positive or negative force on inspection component 104. In an embodiment, tilt mechanism 108 is adapted for multi-angle displacement. The tilt mechanism pivots about multiple angles by using a plurality of memory metal actuators 102, e.g., a plurality of actuators arranged adjacent each other into the plane of the figure. Displacement of metal memory actuators 102 causes the tilt mechanism to tilt in desired angles. In an embodiment, tilt mechanism 108 further includes frictionless pivot 106.

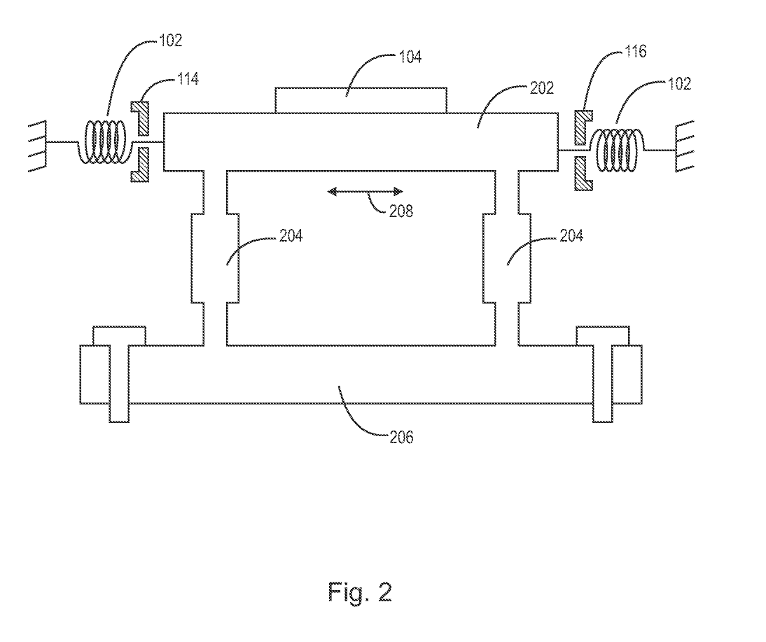

In an example embodiment, shown in FIG. 2, the present invention is an apparatus for actinic EUV reticle inspection comprising translation stage 202 adapted to fixedly connect to inspection component 104, at least one flexure stage 204, and at least one shape memory metal actuator 102 adapted to displace translation stage 202. Shape memory metal actuators 102 are positioned on opposing sides of translation stage 202. The introduction of electric current or another heat source to the shape metal memory actuators results in a push or pull action by the actuators on the translation stage. Translation stage 202 is connected to at least one flexure stage 204, which allows translation stage 202 to displace based on the push or pull action of actuators 102. The flexure stage is connected to base 206. When translation stage 202 is displaced, the inspection component is inspected in different positions. Since the shape memory metal actuators displace using a heat source, minimal, if any, additional particles are introduced into the vacuum chamber of the inspection tool. Unlike traditional actuators that use rubbing motion or lubricants, shape memory metal actuators 102 displace due to the introduction of heat.

In an embodiment, at least one shape memory metal actuator 102 includes first and second shape memory metal actuators, i.e., actuators 102, each adapted to displace translation stage 202. In an embodiment, translation stage 202 includes an original position. Translation stage 202 is displaced from the original position according to bidirectional arrow 208 upon application of an electric current through at least one shape memory metal actuator 102. Translation stage 202 returns to the original position upon the cessation of electric current through at least one shape memory metal actuator 102. In an embodiment, the application of electric current through at least one shape memory metal actuator 102 heats the at least one shape memory metal actuator 102 past a transition point to cause displacement of translation stage 202. In an embodiment, a shield with apertures of differing sizes is mounted to a flexure stage that provides frictionless guided motion. The stage holds the aperture against a first hard stop location that positions the first aperture in the correct location with a spring to provide the seating force. A shape memory metal actuator displaces, or pulls, the aperture plate from the spring loaded first hard stop to an opposing second hard stop. An electrical current flowing through the shape memory metal actuator heats the shape memory metal past its transition point, causing it to change size, or actuate, from an original shape to a new predetermined shape. This change provides the necessary force to overcome the spring and move the plate away from the first hard stop. To keep the aperture plate against the second hard stop location, the electrical current flowing into the shape memory metal is maintained. When the electrical current is removed, the shape memory metal cools and returns to its original shape. This allows the spring to pull the plate back to the first hard stop. In the foregoing, embodiment, component 104 comprises the shield with apertures.

In an embodiment, the original shape of shape memory metal 102 in its cooled state provides the necessary force to return the plate to its original position. This eliminates the need to use a preloading spring. Similar methods can be used to induce changes in angle. For example, instead of pulling a plate along the path prescribed by a flexure stage, shape memory metal actuator 102 pulls an object to create a rotation along a flexure pivot. This tilt moves the plate from a first angle defined by a first hard stop to a second angle defined by a second hard stop. This angular change can occur in more than one direction by providing multiple pivot directions.

In an embodiment, a device reads the position of the translation stage within the inspection tool. By controlling and adjusting the independently controlled temperatures of two shape memory metal actuators, the translation stage is moved to varying intermediate positions. The combination of multiple shape memory metal actuators and flexure stages permits the translation stage to displace into an optimal position where it is held until the electrical current is removed.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. An apparatus for actinic extreme ultra-violet (EUV) reticle inspection comprising:
at least one shape memory metal actuator adapted to displace an inspection component in an EUV inspection tool.

2. The apparatus recited in claim 1, wherein the at least one shape memory metal actuator comprises a wire, a ribbon, a rod, a sheet or a micro-machined shape.

3. The apparatus recited in claim 1, wherein the inspection component comprises at least one of: a spectral purity filter, a grazing incidence angle mirror, a collector, or a sensor.

4. The apparatus recited in claim 1, wherein the inspection component is displaced in a translational motion.

5. The apparatus recited in claim 1, wherein inspection component is displaced in a rotational motion.

6. The apparatus recited in claim 5, wherein the rotational motion comprises a single pivot

7. The apparatus recited in claim 5, wherein the rotational motion comprises a plurality of pivots.

8. The apparatus recited in claim 1 further comprising at least one precision hardstop adapted to locate a destination position for the inspection component.

9. The apparatus recited in claim 1, wherein the at least one shape memory metal actuator comprises one-way metal.

10. The apparatus recited in claim 1, wherein the at least one shape memory metal actuator comprises two-way metal.

11. An apparatus for actinic extreme ultra-violet (EUV) reticle inspection comprising:
a tilt mechanism comprising at least one shape memory metal actuator adapted to angularly displace an inspection component in an EUV inspection tool.

12. The apparatus recited in claim 11, wherein the tilt mechanism is adapted for multi-angle displacement.

13. The apparatus recited in claim 11, wherein the tilt mechanism further comprises a frictionless pivot.

14. The apparatus recited in claim 11, wherein the at least one shape memory metal actuator is in the form of a wire, a ribbon, a rod, a sheet or a micro-machined shape.

15. An apparatus for actinic extreme ultra-violet (EUV) reticle inspection, comprising:
a translation stage adapted to fixedly connect to an inspection component;
at least one flexure stage; and,
at least one shape memory metal actuator adapted to displace the translation stage.

16. The apparatus recited in claim 15, wherein the at least one shape memory metal actuators is in the form of a wire, a ribbon, a rod, a sheet or a micro-machined shape.

17. The apparatus recited in claim 15, wherein the at least one shape memory metal actuator comprises first and second shape memory metal actuators each adapted to displace the translation stage.

18. The apparatus recited in claim 15, wherein the translation stage comprises an original position, the translation stage is displaced from the original position upon application of an electric current through the at least one shape memory metal actuator, and the translation stage returns to the original position upon ceasing application of the electric current through the at least one shape memory metal actuator.

19. The apparatus recited in claim 18, wherein application of the electric current through the at least one shape memory metal actuator heats the at least one shape memory metal actuator past a transition point to cause displacement of the translation stage.
